(19) United States
(12) Patent Application Publication
(10) Pub. No.: US 2019/0210626 A1
(43) Pub. Date: Jul. 11, 2019

(54) ROLLING EQUIPMENT INTENDED TO BE RIDDEN BY A CHILD

(71) Applicant: ID DEVELOPMENT LIMITED, Kowloon (HK)

(72) Inventors: Joseph MAZOYER, Lyon (FR); Philippe BAJARD, Lyon (FR)

(73) Assignee: ID DEVELOPMENT LIMITED, Kowloon (HK)

(21) Appl. No.: 16/242,207

(22) Filed: Jan. 8, 2019

(30) Foreign Application Priority Data
Jan. 8, 2018 (FR) 1850123

(51) Int. Cl. B62B 7/04; B62B 7/06

(52) U.S. Cl. CPC B62B 7/044; B62B 3/001; B62B 7/06

(57) ABSTRACT

The equipment (1) includes: a median front pillar (2a), provided with at least one front wheel (4) at its lower end; a seat (7) located at the upper end of the front median pillar (2a); two pivotable legs (5), pivotally connected, by a front end, to a lower part of the median front pillar (2a), and each including a wheel (6) at a rear end; a slider (18) slidably movable along the front median pillar (2a), and two connecting rods (24) connected to the slider (18), on two opposite sides thereof, and connected to the legs (5); the slider (18) is movable between a lower position, in which the connecting rods (24) bring the legs (5) into the unfolding position and an upper position, in which the connecting rods (24) bring the legs (5) into the folding position; and releasable device (30) for holding the slider (18) in the lower position.

This invention concerns a rolling equipment intended to be ridden by a child.

### BACKGROUND OF THE INVENTION

There are different kinds of equipment designed to be ridden by children. These equipments are often bulky and occupy an important place in a dwelling when not in use.

### OBJECTS OF THE INVENTION

The purpose of this invention is to remedy this significant disadvantage.

There are also folding equipment available; these equipments are not always very easy and fast to unfold and therefore do not give perfect satisfaction.

The present invention also aims to remedy this disadvantage.

### SUMMARY OF THE INVENTION

To achieve at least one of the objects mentioned above, the equipment according to the invention shall comprise:

a median front pillar having lower end and an upper end, comprising at least one front wheel at the lower end;

a seat located at the upper end of the front median pillar;

two pivotable legs having a front end and a rear end; the pivotable legs are pivotally connected by the front ends thereof to a lower part of the median front pillar, each leg comprising a wheel at the rear end; the two legs are pivotably movable in respective pivot planes, between an unfolding position, in which the rear ends of the legs are placed at a distance from said median front pillar and the rear wheels are located, together with the front wheel(s), in a plane extending at a distance from the seat, and a folding position, in which the two legs are moved closer to said front pillar and the rear wheels are located above the seat; the pivot planes of said legs form an acute angle with each other;

a slider having two opposite sides, slidingly movable along said median front pillar, and two connecting rods connected to the slider, on the two opposite sides thereof, and connected to said legs; a first connecting rod is located on a first side of the median front pillar and being connected to a first of said legs, and the second connecting rod being located on a second side of the median front pillar, opposite the first side, and being connected to the second leg; the slider is movable along the front median pillar between a lower position, in which the rods bring said legs into said unfolding position and an upper position, in which the rods bring said legs into said folding position; and

releasable holding device for holding the slider in the said lower position.

It will be understood that terms referring to a spatial arrangement of the equipment, in particular “upper” and “lower”, are to be considered when the equipment is in an unfolded state and with its wheels on the ground, and that the terms “front” and “rear” are to be considered in relation to the normal direction of advance of the equipment on the ground.

In the unfolded state of the equipment, the slider is held by said holding device in said lower position and therefore positions the legs at a distance from said median front pillar and at a distance from the seat; in this state, the axes of the different wheels of the equipment are in a plane substantially parallel to a plane in which the seat generally extends, and located at a distance from this seat, so that the equipment can be used by a child coming to sit on the seat. To bring the equipment into the folding position, said holding device are released so as to allow the sliding of the slider along the median front pillar towards said upper position of this slider; the movement of the slider allows a pivoting of the two legs towards said folding position.

The equipment is thus easily and quickly foldable, and has a reduced volume when in this folded state.

The angle between the two pivot planes in which the two legs pivot can be between 30° and 80°.

Preferably, said at least one front wheel is pivotally mounted on a base fixed to the lower part of the said central front pillar.

This front wheel is thus able to allow the equipment to make turns.

Preferably, said base part forms mounts receiving the front ends of said legs, thus allowing the pivoting mounting of the legs on the median front pillar.

This assembly of the legs is thus carried out in a simple way.

Preferably also, said base part forms a part of said releasable holding device; in particular, when these devices include a pivoting tab mounted on the slider, including a hook portion, said base part forms a cavity defining a hook edge behind which said hook portion is intended to come into releasable engagement.

The base can be made of a single piece of molded plastic, allowing the equipment to be manufactured easily and at a reduced cost.

Advantageously, each leg includes a footrest on which the child can rest one of his feet.

In one embodiment of the invention, the equipment comprises a protruding rod, protruding upwardly from the rear of the seat in an oblique direction inclined towards the rear.

This rod is capable of being grasped by an adult to operate the equipment, so that the adult can maintain control of the equipment.

The rod can be equipped with a terminal handle and may include a length adjustment or folding device.

Preferably, said front median pillar and said protruding rod are rigidly connected to each other by a cross member for receiving the seat and by a rear median post for receiving the protruding rod.

The assembly thus has an appropriate rigidity and high strength.

When the equipment comprises said protruding rod, according to an embodiment, the equipment comprises a guardrail connected, on the one hand, to a front sliding post, located in front of the seat, and, on the other hand, to a rear sliding part, capable to slide along said rear median post; said front sliding post is capable to be slid between an unfolding position, in which it projects upwardly and is capable of placing the guardrail in a functional position, effective to hold a child on the seat, and a folding position in which it is lowered so as to be in a lower position, placing the guardrail in a folding position; said rear sliding part is movable between an unfolding position in which it is in a lower position near the rear of the seat and allows the guardrail to be placed in said functional position, and a folding position in which the rear portion of the guardrail is in an upper position, away from the rear of the seat, and allows the guardrail to be placed in said folding position.

Thus, the mobility of said front sliding post and of said rear sliding part allows, in said unfolding position, to place the guardrail either in said functional position, effective to maintain a child in position on the seat, and, in said folding position, to place the guardrail in a position in which the guardrail is folded down against the seat, so that the equipment has a reduced space requirement.

According to a preferred embodiment of the equipment, when the latter includes this guardrail:

the front sliding post has a transverse gripping bar at its upper part, capable of forming a double handle that the child can grasp in the manner of a handlebar and capable of forming a front portion of the said handrail, and

the equipment comprises removable guardrail parts capable of being connected, on the one hand, to the said transverse gripping bar and, on the other hand, to the said rear sliding part, so as to form the guardrail.

Thus, when the child is very young, the equipment can be used with said removable guardrail parts to form the guardrail, and, when the child is older, these parts can be removed so as to retain only said transverse gripping bar, which is then usable as a double handle to be gripped by the child, in the manner of a handlebar.

According to another characteristic of the invention, said rear sliding part is shaped to form a support backrest for a child's back when the child is sitting on the seat.

According to yet another characteristic of the invention, the equipment comprises a pocket made of a light and flexible material, in particular a net, suitable for hanging under the seat, at the lower end of the front median pillar and at the rear ends of the said pivotable legs.

This pocket thus makes it possible to constitute a storage for various objects, in particular for the child's toys.

The invention shall be well understood, and other characteristics and advantages of the invention shall appear, with reference to the attached schematic drawing, representing, as non-exhaustive examples, several forms of realization of elements that comprise the equipment concerned.

### BRIEF DESCRIPTION OF THE DRAWINGS

FIG. 1 is a view of the equipment in perspective, in an unfolded state, according to a first configuration of this equipment, usable with a slightly older child;

FIG. 2 is a perspective view of a chassis that includes the equipment, at the same angle of view as FIG. 1, this chassis including a central structure, two lower pivotable legs, a lower front base, a slider and two connecting rods connecting this slider to said lower pivotable legs;

FIG. 3 is a partial view of the front part of the said chassis, at an enlarged scale, in cross-section according to the median plane of the chassis of FIG. 2;

FIG. 4 is a perspective view of the equipment at the same viewing angle as FIG. 1, in a folded state of the equipment;

FIG. 5 is a view of the equipment similar to FIG. 1, in a second configuration of this equipment, including a guardrail for use with a very young child; and

FIG. 6 is a view of the equipment similar to FIG. 5, in a folded state.

### DESCRIPTION OF THE PREFERRED EMBODIMENTS

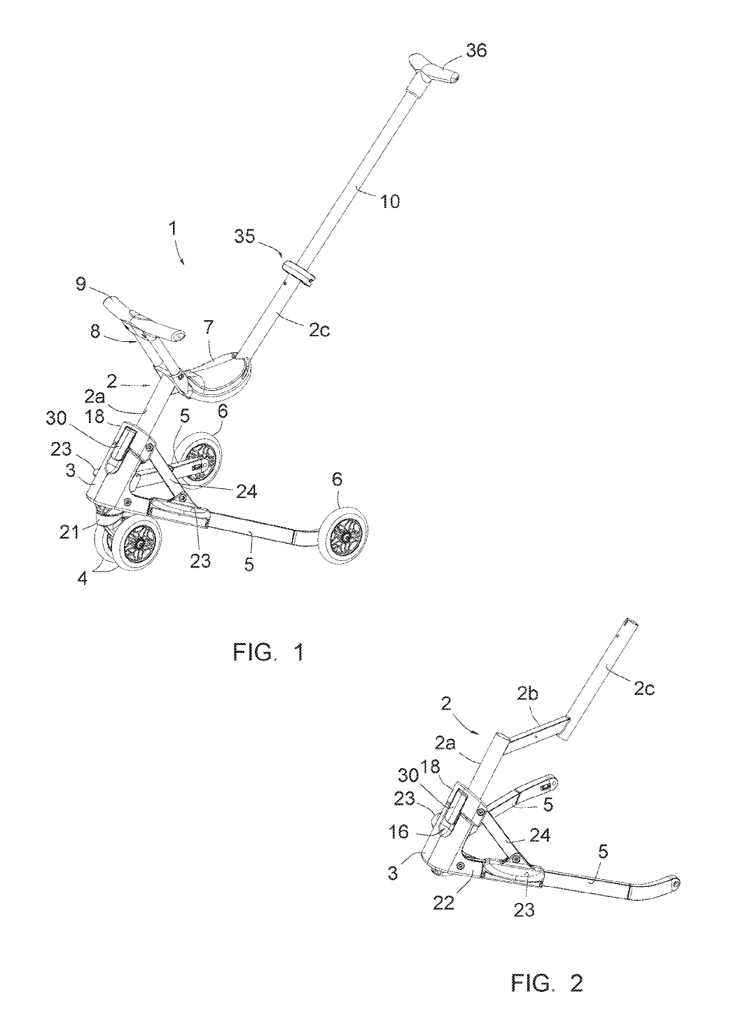

FIG. 1 shows a rolling equipment or vehicle 1 intended to be straddled by a child, consisting essentially of a middle structural element 2, a lower base part 3, a pair of front wheels 4, two pivotable legs 5, rear wheels 6, a seat 7, a post 8 in front of the seat 7, having a crossbar 9, and an oblique rear rod 10.

The middle structural element 2 is most visible in FIG. 2, where seat 7, post 8, bar 9 and handle 10 have been removed. As can be seen, this element 2 includes a lower front pillar 2a, a median cross member 2b and an upper rear post 2c.

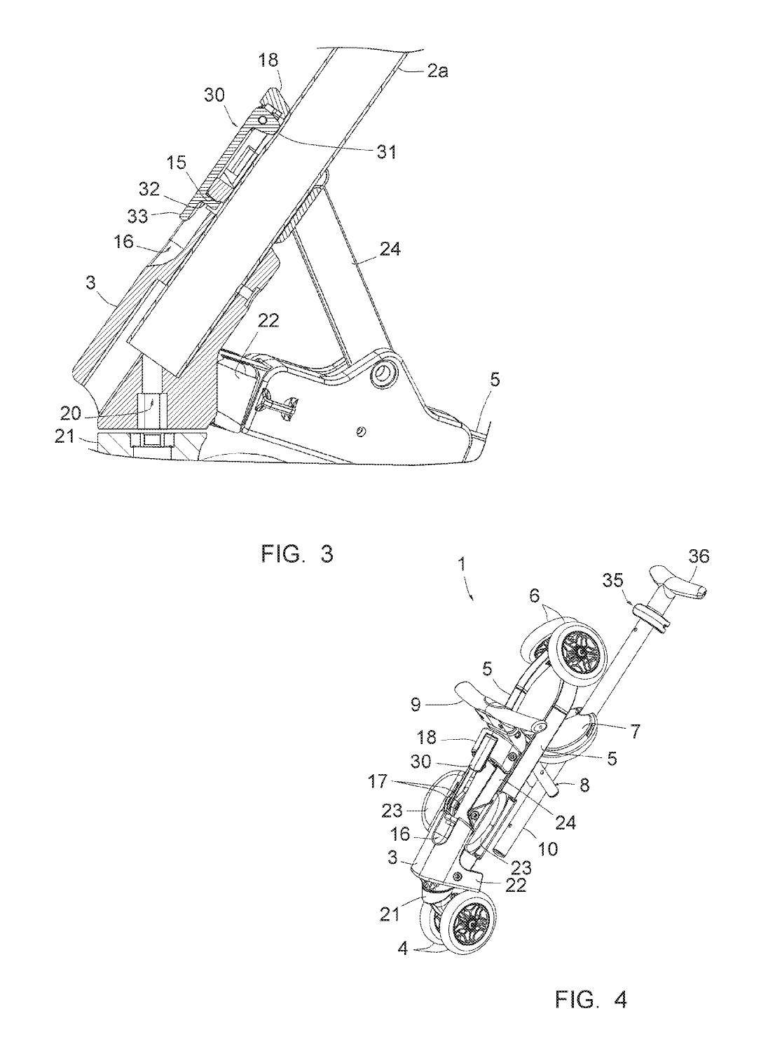

With reference to FIGS. 1 to 3, it appears that the lower front pillar 2a is inclined towards the rear and that it is attached to the lower part of the lower base part 3. The connection between this pillar 2a and base part 3 is made by screws, the base part 3 including for this purpose at least one screw hole visible in FIG. 3.

The median cross member 2b is intended to receive and support the seat 7.

The upper rear post 2c is inclined towards the rear; it is tubular and designed to receive the oblique rear rod 10.

The base part 3 is formed by a molded plastic part; on its front side, it forms a cavity for receiving a hook portion 32 described below, this cavity defining a hook edge 15. Below this cavity, the base part 3 forms a recess 16 allowing the engagement of a finger of the user to lift a swivel tab 30 described below, including said hook portion 32.

At its upper part, the base part 3 is connected to two convex leaf springs 17, visible in FIGS. 4 and 6; these springs 17 are capable, by their elastic deformability, to be crossed by a slider 18 engaged on the pillar or column 2a when this slider 18 is in a position close to the base part 3 and constitute abutment points that can be overcome, ensuring the positioning of this slider 18 in this position of proximity with the base part 3.

At its lower part, the base part 3 has a vertical cavity 20 for receiving a connecting pin fixed to a wheel carrier 21 on which the pair of front wheels 4 is mounted.

Also, at its lower part, the base part 3 has two mounts 22 in which the legs 5 are mounted pivotably. These two mounts 22 form an angle of about 70° with each other so that the two pivot planes in which the said legs 5 pivot form an identical angle with each other; the two legs 5, in the unfolding position of the equipment 1 shown in FIG. 1, also form an identical angle with each other.

Each leg 5 is pivotally connected, by a front end, to a mount 22 of the base part 3, and includes a wheel 6 at a rear end. It includes, attached to it, on the side of the mount 22, a footrest 23 on which the child can rest his foot when sitting in seat 7. This footrest 23 forms a mount to which is connected a connecting rod 24, itself connected to the slider 18 by its opposite end.

With particular reference to FIGS. 1 and 3, it appears that the slider 18 has said swivel tab 30, connected to it at an upper end. At this upper end, tab 30 forms a support cam 31 bearing against the pillar 2a; at its lower end, tab 30 forms said hook portion 32 and a protruding lower longitudinal part 33 constituting a support surface for lifting tab 30 with respect to slider 18.

Seat 7 is made up of a molded plastic part. Returning to FIG. 1, it appears that this part forms a pair of front tubes inclined forward.

The front post 8 is located in front of the seat 7 and is formed by two parallel tubes slidingly engaged in the pair of front tubes formed by the part forming the seat 7. Rounded pins associated with springs inside the tubes forming the post 8 are suitable for fitting in holes in said front tubes so as to fix the post 8 in the unfolding position shown in FIG. 1. These pins can be inserted in these holes so as to be removed from the holes and thus make it possible to slide the post 8 into the folding position shown in FIG. 4. Such a pin, spring and hole system is of the type well known on children's equipment with sliding tubes to be held in one or more positions, in particular on scooters.

The crossbar 9 is slightly curved and forms a double handle that can be grasped by a child sitting on seat 7, like a handlebar.

The oblique rear rod 10 is slidably engaged in the inclined upper post 2c and is suitable for sliding inside this post 2c. It can be immobilized in a determined position by a circumferential clamping system, well known in itself, and in particular of the same type as a system used to immobilize the tube of a saddle of a bicycle. Rod 10 includes a grip handle 36 at its upper end, intended to be grasped by an adult to operate the equipment or vehicle 1.

When comparing FIGS. 1 and 4, it is understood that the two legs 5 are pivotally movable between the unfolding state shown in FIG. 1, in which the rear ends of the legs 5 are placed at a distance from the front pillar 2a and the rear wheels 6 are located, with the front wheels 4, in a plane extending at a distance from the seat 7, and the folding state shown in FIG. 4, in which the two legs 5 are moved closer to the pillar 2a and the rear wheels 6 are located above the seat 7, one near the other. In FIG. 4, too, it appears that post 8 is in a lowered position and rod 10 is retracted into the rear post 2c, thus reducing the space requirement of the equipment, or device or vehicle 1.

In the unfolded state, the slider 18 is held in its lower sliding position along the upright 2a by the engagement of the hook portion 32 formed by the tab 30 behind the hook flange 15 formed by the base part 3.

To change from the unfolding state shown in FIG. 1 to the folding state shown in FIG. 4, the user lifts tab 30 so as to release it from its engagement with the base part 3 and then pivot the middle structural element 2 towards the legs 5, leading the slider 18 to its upper sliding position shown in FIG. 4 and bringing the legs 5 into the folding position shown in FIG. 4. The upright 8 and the rod 10 are brought into their folded position also shown in FIG. 4.

To unfold equipment 1, the median structural element 2 is moved away from the legs 5 in an opposite movement, until it brings tab 30 into engagement with the base part 3 and thus immobilizes equipment 1 in its unfolding position.

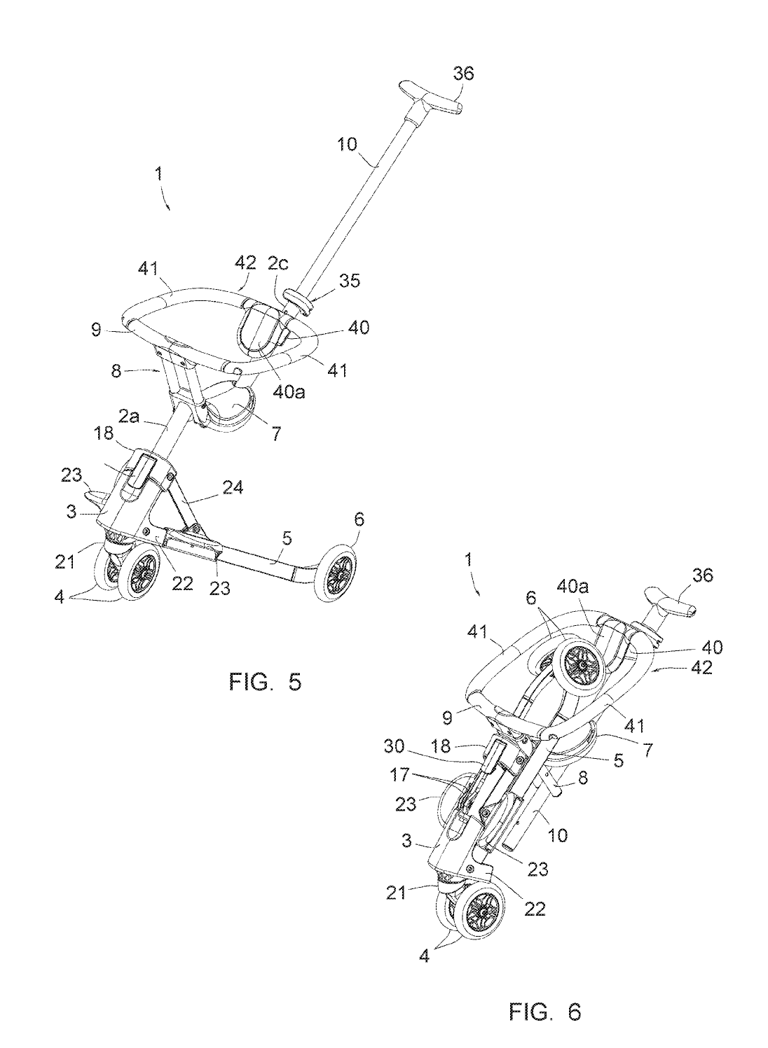

FIGS. 5 and 6 show an equipment 1 with the same structure as the one described above; the elements already described are designated by the same numerical references.

This equipment 1 includes a sliding rear part 40, slidingly engaged on the inclined rear post 2c, which also forms, on the forward-facing side of equipment 1, a backrest 40a against which the child sitting in seat 7 can rest his back.

On this equipment 1, removable guardrail parts 41 have connecting portions that can be connected to corresponding connecting portions on the ends of the bar 9 and connecting portions that can be connected to corresponding connecting portions on the rear part 40. These guardrail parts 41 can thus be connected to the bar 9 and the rear part 40, thus forming, together with said bar 9 and part 40, a continuous guardrail 42 suitable for holding a very young child in position on seat 7.

By comparing FIGS. 5 and 6, it is understandable that the front post 8 is capable to slide between the unfolding position (see FIG. 5), in which it projects upwards and is capable to place the guardrail 42 in a functional position, effective to hold a child on the seat 7, and a folding position (see FIG. 6) in which it is lowered so as to be in a lower position, placing the guardrail 42 in a space-saving folding position; said rear sliding part 40 is movable between an unfolding position (see FIG. 5) in which it is in a lower position close to the rear of the seat 7 and allows the guardrail 42 to be placed in said functional position, and a folding position (see FIG. 6) in which the rear portion thereof is in an upper position, remote from the rear of the seat 7, and allows the guardrail 42 to be placed in said folding position.

It appears from the above that the invention provides a rolling equipment or vehicle intended to be ridden by a child, having the decisive advantages of being compact in the folding state and of being very easy and quick to unfold, according to a simple and intuitive operating mode.

The invention has been described above with reference to embodiments provided only as examples. It goes without saying that it extends to all other embodiments covered by the appended claims.

What is claimed is:

1. A rolling equipment intended to be ridden by a child, comprising:
a median front pillar having lower end and an upper end, comprising at least one front wheel at the lower end;
a seat located at the upper end of the front median pillar;
two pivotable legs having a front end and a rear end; the pivotable legs are pivotally connected by the front ends to a lower part of the median front pillar, each leg comprising a wheel at the rear end; the two legs are pivotably movable in respective pivot planes, between an unfolding position, in which the rear ends of the legs are placed at a distance from said median front pillar and the rear wheels are located, together with the front wheel(s), in a plane extending at a distance from the seat, and a folding position, in which the two legs are moved closer to said front pillar and the rear wheels are located above the seat; the pivot planes of said legs form an acute angle with each other;
a slider having two opposite sides, slidingly movable along said median front pillar, and two connecting rods connected to the slider, on the two opposite sides, and connected to said legs; a first connecting rod is located on a first side of the median front pillar and being connected to a first of said legs, and the second connecting rod being located on a second side of the median front pillar, opposite the first side, and being connected to the second leg; the slider is movable along the front median pillar between a lower position, in which the rods bring said legs into said unfolding position and an upper position, in which the rods bring said legs into said folding position; and
releasable holding device for holding the slider in the said lower position.

2. The equipment according to claim 1, wherein the angle between the two pivot planes in which the two legs pivot is between 30° and 80°.

3. The equipment according to claim 1, wherein said at least one front wheel is pivotally mounted on a base fixed to the lower part of the said central front pillar.

4. The equipment according to claim 3, wherein said base part forms mounts receiving the front ends of said legs and thus allows the pivoting mounting of the legs on the median front pillar.

5. The equipment according to claim 3, wherein said base part forms some of said releasable holding device.

6. The equipment according to claim 5, wherein:
said releasable holding device comprises a pivoting tab mounted on the slider, including a hook portion; and
said base part forms a cavity delimiting a hook edge behind which said hook portion is intended to come into releasable engagement.

7. The equipment according to claim 1, wherein each leg comprises a footrest on which the child can rest one of his feet.

8. The equipment according to claim 1, wherein it comprises a protruding rod, protruding upwardly from the rear of the seat in an oblique direction inclined towards the rear.

9. The equipment according to claim 8, wherein said front median pillar and said protruding rod are rigidly connected to each other by a crossbar for receiving the seat and by a rear median post for receiving the protruding rod.

10. The equipment according to claim 9, wherein the equipment comprises a guardrail connected, on the one hand, to a front sliding post, located in front of the seat, and, on the other hand, to a rear sliding part, capable to slide along said rear median post; said front sliding post is capable to be slid between an unfolding position, in which it projects upwardly and is capable of placing the guardrail in a functional position, effective to hold a child on the seat, and a folding position in which it is lowered so as to be in a lower position, placing the guardrail in a folding position; said rear sliding part is movable between an unfolding position in which it is in a lower position near the rear of the seat and allows the guardrail to be placed in said functional position, and a folding position in which the rear portion of the guardrail is in an upper position, away from the rear of the seat, and allows the guardrail to be placed in said folding position.

11. The equipment according to claim 10, wherein:
the front sliding post has a transverse gripping bar at an upper part, capable of forming a double handle that the child can grasp in the manner of a handlebar and forming a front portion of the said handrail, and
the equipment comprises removable guardrail parts connected, on the one hand, to the said transverse gripping bar and, on the other hand, to the said rear sliding part, so as to form the guardrail.

12. The equipment according to claim 10, wherein said rear sliding part is shaped to form a support backrest for the back of the child sitting on the seat.

13. The equipment according to claim 1, wherein the equipment comprises a pocket made of a light and flexible material, in particular a mesh material, hanging under the seat, at the lower end of the front median pillar and at the rear ends of said pivotable legs.
